(19) United States
(12) Patent Application Publication
(10) Pub. No.: US 2016/0214299 A1
(43) Pub. Date: Jul. 28, 2016

(54) MEASUREMENT APPARATUS

(71) Applicant: Futaba Corporation, Mobara-shi (JP)

(72) Inventors: Ryoichiro HAYANO, Mobara-shi, Chiba-ken (JP); Yasuhiro NOHARA, Mobara-shi (JP); Yasunori IIYA, Mobara-shi (JP); Yasuo ISHIWATA, Mobara-shi (JP)

(21) Appl. No.: 14/994,292

(22) Filed: Jan. 13, 2016

(30) Foreign Application Priority Data
Jan. 27, 2015 (JP) 2015-013320

(51) Int. Cl. B29C 45/76; B29C 45/77; B29C 45/04

(52) U.S. Cl. CPC B29C 45/76; B29C 45/768; B29C 45/045; B29C 45/77; B29C 2945/76006; B29C 2945/76381; B29C 2945/76551

(57) ABSTRACT

A measurement apparatus for receiving a detection signal as a measurement target signal from a sensor provided at an injection molding apparatus which includes molds and selectively injects a molding material into each of the molds, includes input terminals to which trigger signals outputted from the injection molding apparatus are inputted. The trigger signals indicates timing of injecting the molding material into each of the molds.

### CROSS-REFERENCE TO RELATED APPLICATIONS

This application claims priority to Japanese Patent Application No. 2015-013320 filed on Jan. 27, 2015, the entire contents of which is incorporated. herein by reference.

### FIELD OF THE INVENTION

The disclosure relates to a measurement apparatus for sampling a detection signal inputted as a measurement target signal from a sensor installed at an injection molding apparatus which includes molds and selectively injects a molding material into each of the molds, e.g., a rotary table type injection molding apparatus or the like.

### BACKGROUND OF THE INVENTION

There is known an injection molding measurement. system including a measurement apparatus and a sensor installed at an injection molding apparatus. The injection molding measurement system is configured to detect behavior of the molding material such as resin. or the like in the mold of the injection molding apparatus by using the sensor and output a waveform as a detection result to an information processing apparatus such as a personal computer or the like in real time. A measurement data can be utilized for setting of optimal molding conditions, automatic sorting of inferior goods, quality management, mold evaluation and the like. Further, the injection molding measurement system can monitor a measurement value based on the detection signal of the sensor and output an alarm when abnormality occurs. By outputting the alarm, the operation of the injection molding apparatus can be stopped or the inferior goods can be distinguished.

Japanese Patent Application Publication No. 2008-36975 discloses a technique in which a sensor (load cell 20) installed at an injection molding apparatus detects a pressure of resin in a cavity and an amplifier amplifies the detection signal of the sensor.

As for the injection molding apparatus, there is known, e.g., a rotary table type injection molding apparatus or the like which includes molds and selectively injects a molding material into each of the mold (see, e.g., Japanese Patent Application Publication Nos. 2008-254260 and 2005-119117). For example, in case where two mol are provided on a rotary table such as A surface and B surface, the molding material is alternately injected into the A surface and the B surface by rotation of the rotary table.

In an injection molding measurement system for the injection molding apparatus which selectively injects a molding material into molds, it is preferable to perform individually measurement or abnormality detection for each mold.

To do so, it is considered to employ a system having a configuration in which a sensor is provided at each mold in the injection molding apparatus and a sensor detection. signal from the sensor of each mold. is inputted to each of measurement apparatuses provided as many as the number of the molds.

However, in the case of providing the measurement apparatuses as many as the number of the molds, the cost is increased, which is not preferable.

### SUMMARY OF THE INVENTION

In view of the above, the disclosure provides a measurement apparatus capable of separately performing measurement using a sensor detection. signal on a mold basis, in an injection molding measurement system for an injection molding apparatus which selectively injects a molding material into molds, thereby preventing an increase of the cost.

In accordance with an embodiment of the disclosure, there is provided a measurement apparatus for receiving a detection signal as a measurement target signal from sensor provided at an injection molding apparatus which includes molds and selectively injects a molding material into each of the molds, the apparatus includes: input terminals to which trigger signals outputted from the injection molding apparatus are inputted, the trigger signals indicating timing of injecting the molding material into each of the molds.

By using the measurement apparatus, it is possible to identify a mold corresponding to the input trigger signal by checking an input terminal to which the trigger signal is inputted.

The above described measurement apparatus further includes an operation unit configured to perform mold determination for determining a mold. into which the molding material is being injected based on one of the input terminals to which each of the trigger signals is inputted and separately perform a measurement process using the detection signal on a mold basis depending on the result of the mold determination.

Accordingly, the measurement process can be separately performed for each mold into which the molding material is injected.

In the above described measurement apparatus, the operation unit performs abnormality determination to determine whether or not a measurement value is abnormal using the detection signals in response to each input of the trigger signals, and wherein when the operation unit determines that the measurement value is abnormal, an alarm signal for the mold determined in the mold determination is outputted.

Accordingly, the abnormality determination and the alarm output can be individually performed for each mold into which the molding material is injected.

In the above described measurement apparatus, the operation unit selects an abnormality determination method to be used in the abnormality determination depending on the result of the mold determination.

Accordingly, the abnormality determination method can be switched on a mold basis.

In the above described measurement apparatus, the sensor is a pressure sensor for detecting a pressure of the molding material injected into the mold, and the operation unit performs a pressure measurement using the detection signal.

The pressure of the molding material injected into the mold (cavity) is an important factor in determining quality of molding.

In the above described measurement apparatus, the injection molding apparatus is a rotary table type injection molding apparatus in which the molds are provided on a rotary table.

In the rotary table type injection molding apparatus, the positions of the molds are changed by the rotation, so that it is difficult for an operator or the like to identify a mold into which the molding material is being injected through eye observation. Therefore, the measurement apparatus of the disclosure is suitable for the rotary table type injection molding apparatus.

The disclosure can provide the measurement apparatus capable of separately performing measurement using a sensor detection signal on a mold basis, in the injection molding measurement system for the injection molding apparatus which selectively injects a molding material into each of the molds, thereby preventing an increase of the cost.

### BRIEF DESCRIPTION OF THE DRAWINGS

The objects and features of the disclosure will become apparent from the following description of embodiments, given in conjunction with the accompanying drawings, in which:

FIG. 1 shows a schematic configuration of an injection molding measurement system according to a first embodiment;

FIG. 2 explains an internal configuration of a measurement apparatus according to the first embodiment;

FIG. 3 shows an example of a setting screen by a management software;

FIG. 4 explains an abnormality determination method for a pressure measurement value;

FIG. 5 is a flowchart of a pressure measurement process; and

FIG. 6 shows a configuration of an injection molding measurement system according to a second embodiment.

### DETAILED DESCRIPTION OF THE EMBODIMENTS

Hereinafter, embodiments of the disclosure will be described.

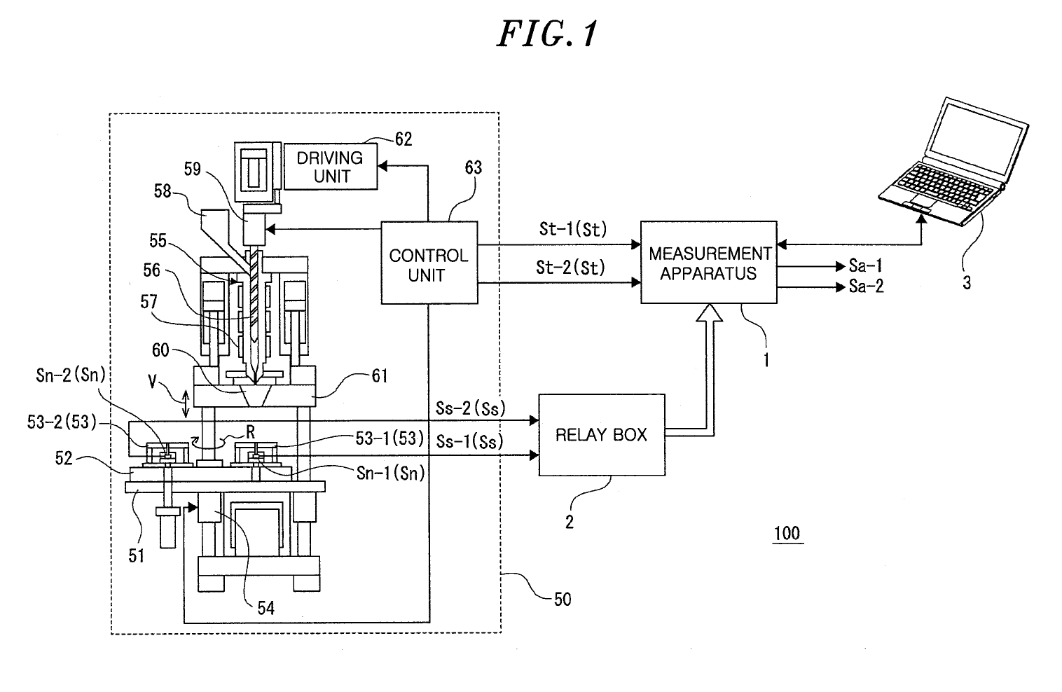

FIG. 1 shows a schematic configuration of an injection molding measurement system 100 according to a first embodiment.

As shown in FIG. 1, the injection molding measurement system 100 includes an injection molding apparatus 50, a measurement apparatus 1, a relay box 2, and a personal computer 3.

A vertical type apparatus is employed as the injection molding apparatus 50. The injection molding apparatus 50 is configured as a rotary table type injection molding apparatus having a rotary table 52. The rotary table 52 is provided on a fixing stage 51. Lower molds 53 are provided on the rotary table 52. In this example, the lower mold 53 includes a lower mold 53-1 and a lower mold 53-2. Hereinafter, the lower mold 53-1 will be referred to as “first mold 53-1” and the lower mold 53-2 will be referred to as “second mold 53-2”.

The rotary table 52 is configured to be rotatable along a direction indicated by an arrow R in FIG. 1 by a motor 54. By the rotation of the rotary table 52, the positions of the first mold 53-1 and the second mold 53-2 can be switched.

The injection molding apparatus 50 includes: a moving stage 61 in which an upper mold 60 is provided; an injection cylinder 55 for injecting a molding material into the upper mold 60; an injection motor 59 for rotating a screw 56 in the injection cylinder 55; and a driving unit 62 having a motor and a driving unit for integrally displacing the moving stage 61, the injection cylinder 55 and the injection motor 59 in a direction indicated by an arrow V in FIG. 1, i.e., in a direction of approaching/separating them to/from the first mold 53-1 or the second mold 53-2 on the rotary table 52; and a control unit 63 for controlling the motor 54, the injection motor 59 and the driving unit 62.

The control unit 63 includes a microcomputer having, e.g., a ROM (Read Only Memory), a RAM (Random Access Memory), and a CPU (Central Processing Unit).

The injection cylinder 55 has a material input unit 58 for inputting a molding material, e.g., resin or the like, into the injection cylinder 55, and a heater 57 for dissolving the inputted molding material.

The control unit 63 controls the motor 54, the injection motor 59 and the driving unit 62 to perform an injection molding using the upper mold 60 and the first or second mold 53-1 or 53-2. Specifically, the control unit 63 controls the motor 54 to dispose the first mold 53-1 at a position corresponding to the upper mold 60. In that state, the control unit 53 controls the driving unit 62 to move the upper mold 60 in a direction toward the first mold 53-1, thereby closing the upper mold 60 and the first mold 53-1. In that state, the injection motor 59 is rotated to inject the dissolved molding material from the injection cylinder 55 into the cavity formed by the first mold 53-1 and the upper mold 60 that are closed. Accordingly, the injection molding using the upper mold 60 and the first mold 53-1 is performed.

Hereinafter, a period in which the injection. molding using the upper mold 60 and the first mold 53-1 is performed is referred to as “first injection molding period”.

Upon completion. of the first injection molding period, the control unit 63 controls the motor 54 to dispose the second mold 53-2 at the position corresponding to the upper mold 60. In that state, the control unit 63 controls the driving unit 62 to move the upper mold 60 in a direction toward the second mold 53-2, thereby closing the upper mold 60 and the second mold 53-2. In that state, the injection. motor 59 is rotated to inject the dissolved molding material from the injection cylinder 55 into the cavity formed by the second mold 53-2 and the upper mold 60 that are closed. Accordingly, the injection molding using the upper mold 60 and the second mold 53-2 is performed.

Hereinafter, a period in which the injection molding using the upper mold 60 and the second mold 53-2 is performed is referred to as “second injection molding period”.

The measurement apparatus 1 of this example is configured as a pressure measurement apparatus for measuring a pressure of a molding material that is injected in the first injection molding period and the second injection molding period.

In the injection molding apparatus 50, a pressure sensor Sn for detecting a pressure is provided at each of the first mold 53-1 and the second mold 53-2. The pressure sensor Sn provided at the first mold 53-1 is referred to as “first pressure sensor Sn-1”. The pressure sensor Sn provided at the second mold 53-2 is referred. to as “second pressure sensor Sn-2”.

As for the pressure sensor Sn, it is possible to use, e.g., a flush mounting type sensor which is direct type, a button type sensor which is indirect type, an ejector pin type sensor or the like.

In this example, a diaphragm gauge type pressure sensor is used for the first pressure sensor Sn-1 and the second. pressure sensor Sn-2. A measurable pressure range thereof is, e.g., about 0 MPa to 100 MPa.

The first pressure sensor Sn-1 is provided at the first mold 53-1 so that the injection pressure of the molding material injected into the cavity formed by the upper mold 60 and the first mold 53-1 can be detected in the first injection molding period.

The second pressure sensor Sn-2 is provided at the second mold 53-2 so that the injection pressure of the molding material injected into the cavity formed by the upper mold 60 and the second mold 53-2 can be detected in the second injection molding period.

A first detection signal Ss-1 of the first pressure sensor Sn-1 and a second detection signal Ss-2 of the second pressure sensor Sn-2 are inputted to the measurement apparatus 1 through. the relay box 2.

The relay box 2 is configured to receive detection signals Ss of systems (channels) and output the inputted detection signals Ss to the measurement. apparatus 1 through a single relay cable.

In this example, the relay box 2 and the relay cable are used for transmission of detection signals Ss of at most 4CHs (channels). In other words, the detection signals Ss of at most 4CHs can be inputted to the measurement apparatus 1 of this example through a single relay cable.

A first trigger signal St-1 and a second trigger signal St-2 are inputted. from the control unit 63 of the injection molding apparatus 50 into the measurement apparatus 1. The first trigger signal St-1 is generated by the control unit 63 and indicates a start timing of the first injection molding period. The second trigger signal St-2 is generated by the control unit 63 and indicates a start timing of the second injection molding period.

The measurement apparatus 1 measures pressures in the first injection molding period. and the second injection molding period using the first trigger signal St-1, the second trigger signal St-2, the first detection signal Ss-1, and the second detection signal Ss-2.

Further, the measurement apparatus 1 performs abnormality determination by monitoring the pressure measurement values in the first injection molding period and the second injection molding period. and outputs a first alarm signal Sa-1 and a second alarm signal Sa-2 depending' on the abnormality detection result. This will be described in detail later.

The first alarm signal Sa-1 and the second alarm signal Sa-2 can be inputted as an abnormality notification signal into the injection molding apparatus 50 (the control unit 63).

Pressure measurement results obtained by the measurement apparatus 1 can be read through the personal computer 3 connected to the measurement apparatus 1.

Installed at the personal computer 3 is a management software for managing the pressure measurement of the measurement apparatus 1. The management software enables an operator or the like to check the pressure measurement results obtained by the measurement apparatus 1 through a display of the personal computer 3. In this example, the operator or the like can store the pressure measurement results in a predetermined storage device such as a HDD (Hard Disk Drive) or a SSD (Solid State Disk) of the personal computer 3 by the setting using the management software.

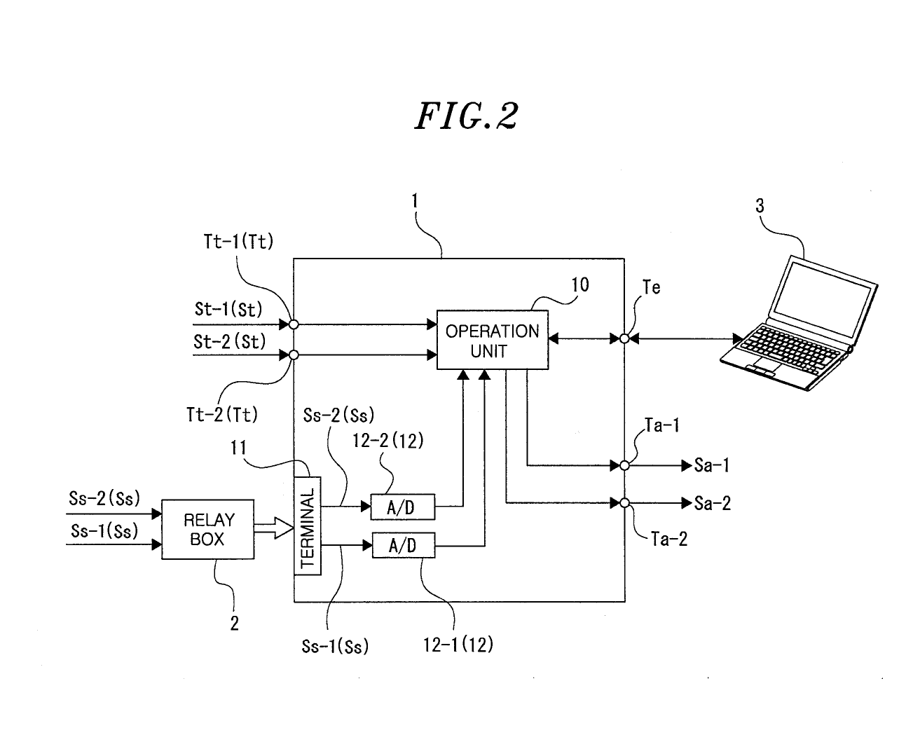

FIG. 2 explains an internal configuration of the measurement apparatus 1.

In FIG. 2, the relay box 2 and the personal computer are illustrated in addition to the internal configuration of the measurement apparatus 1. The measurement apparatus 1 includes: a terminal 11 to which the relay box 2 is connected through the relay cable; a first trigger signal input terminal Tt-1 to which the first trigger signal St-1 is inputted; a second trigger signal input terminal Tt-2 into which the second trigger signal St-2 is inputted; a data communication terminal Te for performing data communication with an external information processing apparatus, especially the personal computer 3 in this example; a first alarm signal output terminal Ta-1 serving as an output terminal of the first alarm signal Sa-1; a second alarm signal output terminal Ta-2 serving as an output terminal of the second alarm signal Sa-2; A/D converters 12; and an operation unit 10 including a microcomputer having a POM, a RAM, and a CPU.

In this example, the data communication terminal Te is an Ethernet (Registered Trademark) terminal. The measurement apparatus 1 and the personal computer 3 are connected through a LAN (Local Area Network) cable.

A connector of the relay cable is detachably connected to the terminal 11 which has input terminals for detection signals as many as the number of the channels (4CHs in this example) of the detection signals Ss that can be transmitted through the relay cable.

The number of the A/D converters 12 is equal to the number of the channels of the detection signals Ss that can be transmitted through the relay cable. In this example, the number of the pressure sensors Sn is two and the number of the channels of the detection signals inputted to the measurement apparatus 1 is two. Therefore, only the A/D converters 12-1 and 12-2 are illustrated as the A/D converter 12, and the illustration of the other is omitted. The A/D converter 12-1 is connected to the input. terminal for the first detection signal Ss-1 in the terminal 11. The A/D converter 12-2 is connected to the input terminal for the second. detection. signal Ss-2 in the terminal 11.

The A/D converter 12-1 and the A/D converter 12-2 perform A/D conversion (sampling) of the first detection. signal Ss-1 and the second detection signal Ss-2 and output the converted signals to the operation unit 10.

In addition to the converted first detection. signal Ss-1 and the converted second detection signal Ss-2, the first trigger signal St-1 and the second trigger signal St-2 are also inputted to the operation unit 10 through the first trigger signal input terminal Tt-1 and the second trigger signal input terminal Tt-2, respectively.

The operation. unit 10 separately performs calculation of the measurement value of the pressure and abnormality determination of the measurement value for each of the first mold 53-1 and the second mold 53-2, based on the inputted signals.

At this time, the operator or the like can previously set the measurement apparatus 1, by using the management software in the personal computer 3, to perform calculation for the measurement value of the detection signal inputted through any of the channels in accordance with given correlation between. the channels and the first and second trigger signal St-1 and St-2.

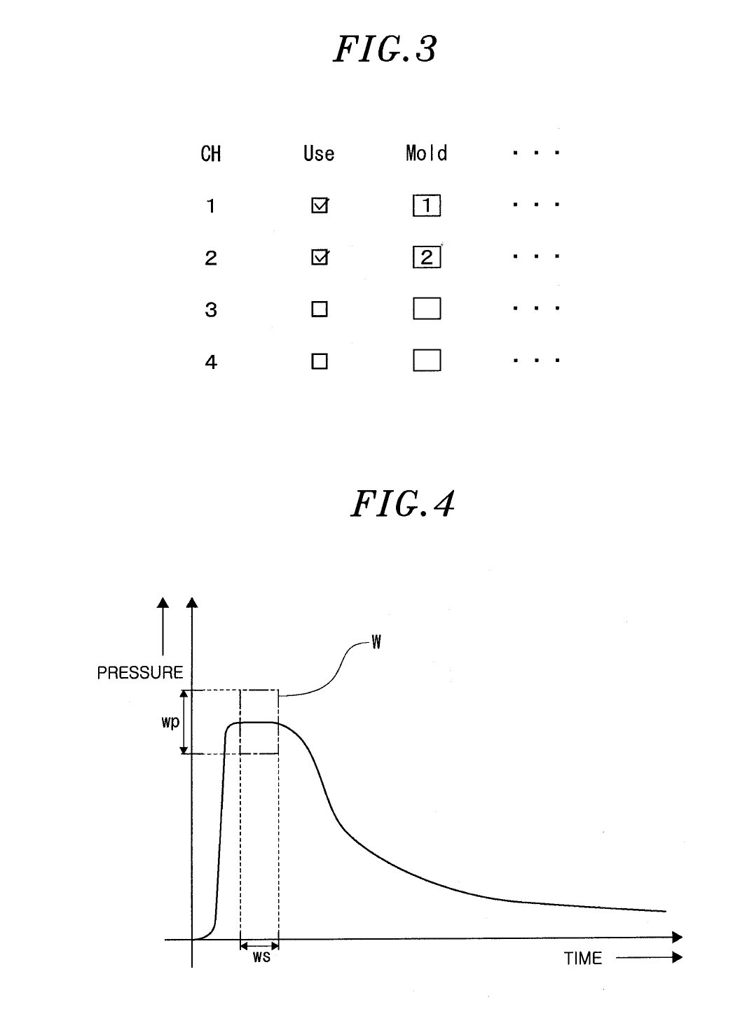

FIG. 3 shows an example of a setting screen of the management software.

As illustrated in FIG. 3, there are displayed on the setting screen a check box (“Use” item in FIG. 3) for selecting use (or not use) for each channel CH of the detection signals Ss and a mold number input box (“Mold” item in the drawing) for determining correlation between a mold. and a channel. In this example, the mold number “1” corresponds to the first mold 53-1 and the mold number “2” corresponds to the second mold 53-2. In other words, the mold number “1” serves as information for selecting the first trigger signal St-1 and the mold number “2” serves as information for selecting the second trigger signal St-2.

FIG. 3 shows the case of setting a mold number of CH1 to “1” and a mold number of 01-12 to “2” when the first pressure sensor Sn-1 is connected to CH1 and the second pressure sensor Sn-2 is connected to CH2.

The operator or the like sets the correlation between the channels and the molds by using the setting screen. in a state where the personal computer 3 is connected to the measurement apparatus I.

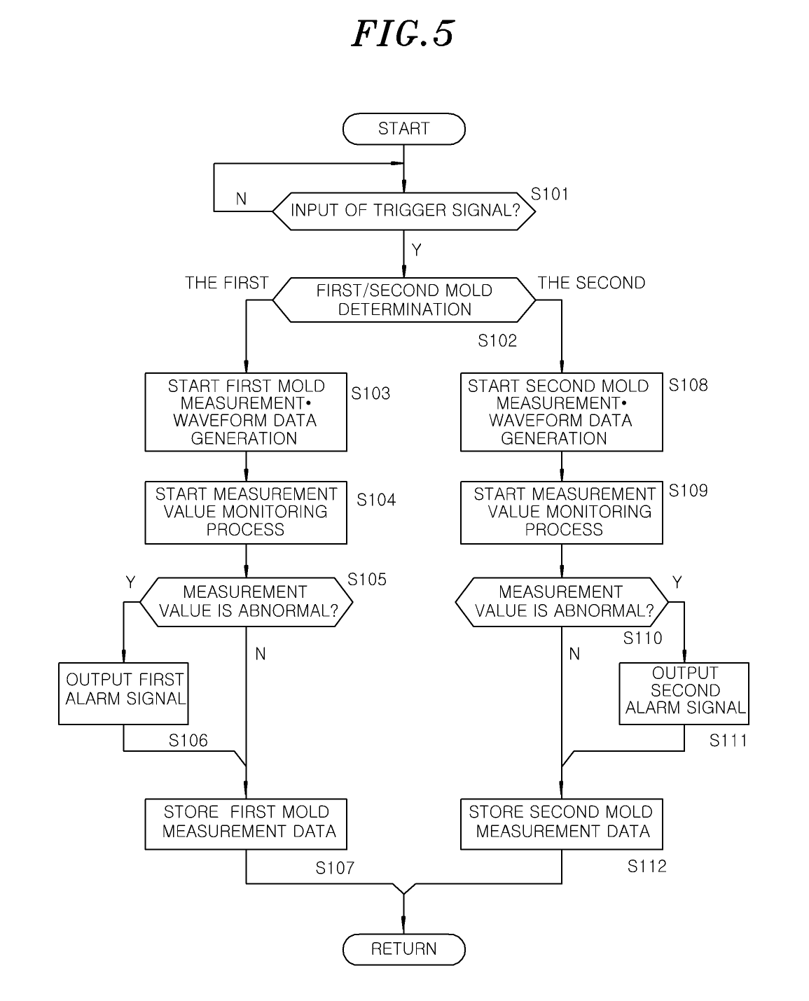

FIG. 4 explains an abnormality determination method for the pressure measurement value which is performed by the operation unit 10. FIG. 4 schematically shows changes of the pressure measurement value based on the detection. signals Ss obtained during the injection molding.

Whether the measurement value is abnormal or not is determined depending on whether or not the measurement value is presented in a preset window W. The range of the window W is defined by a monitoring period ws and a monitoring range wp. The monitoring period ws is a variable parameter and is a period after the start timing of the injection. molding (input timing of the first trigger signal St-1 or the second trigger signal St-2). The monitoring range wp is also a variable parameter. The operator or the like can set the monitoring period ws and the monitoring range wp in the measurement apparatus 1 (the operation unit 10) by using the management software.

In this example, the monitoring period ws and the monitoring range wp can be individually set for each of the mold number “1” and the mold number “2”.

FIG. 5 is a flowchart of the pressure measurement process performed by the operation unit 10.

The process shown in FIG. 5 is performed based on a program. stored in a predetermined. storage device such as the ROM or the like by the CPU of the operation unit 10.

In FIG. 5, it is assumed that the sensors are connected such that the first detection signal Ss-1 is inputted to CH1 of the detection signal Ss and the second detection signal Ss-2 is inputted to CH2 of the detection signal Ss and also that the mold number “1” (the first trigger signal St-1) and the mold number “2” (the second trigger signal St-2) are set for CH1 and CH2, respectively (i.e., the connection of the sensors to the channels CHs and the correspondence of the trigger signals St to the channels CHs are made correct) as described in FIG. 3.

Referring to FIG. 5, the operation unit 10 waits for the input of the trigger signal St in a step S101. In other words, the operation unit 10 waits for the input. of the first trigger signal St-1 into the first trigger signal input terminal Tt-1 or the input of the second trigger signal St-2 into the second trigger signal input terminal Tt-2.

When any one of the trigger signals St is inputted, the operation unit 10 performs the determination on the first or second mold in a step S102. In other words, it is determined whether the inputted trigger signal St is the first trigger signal St-1 for the first trigger signal input terminal Tt-1 or the second trigger signal St-2 for the second trigger signal input terminal Tt-2.

When the first trigger signal St-1 is inputted, the operation unit 10 proceeds to a step S103 and starts measurement for a first mold and waveform data generation process. In other words, the operation unit starts a pressure measurement value calculation process based on the input detection signal (the first detection signal Ss-1) of CH1 which is made to correspond to the mold number “1” by the setting and a waveform data generation. process based on the calculated pressure measurement. value.

Next, in a step S104, the operation unit 10 starts a measurement value monitoring process. In other words, the operation unit 10 starts the measurement value monitoring process for abnormality determination using the window W.

Next, in a step S105, the operation unit 10 determines whether or not the measurement value is abnormal. In this example, the process of determining whether or not the measurement value is abnormal is performed by using a window W that is set for each mold number by the management software. Specifically, in the step S105, a window W set for the mold number “1” corresponding to the inputted first trigger signal St-1 is selected and the abnormality determination is performed by using the selected window W.

When it is determined in the step S105 that the measurement value is not abnormal, the operation unit 10 proceeds to a step S107 and performs a first mold measurement data storing process. In other words, the operation unit 10 stores the measurement data obtained by the first mold measurement and waveform data generation process of the step ST103. On the other hand, when it is determined in the step

S105 chat the measurement value is abnormal, the operation unit 10 proceeds to a step S106 and outputs the first alarm signal Sa-1, and then proceeds to a step S107 and performs a data storing process.

As for the measurement. data storing process in the step S107, there are performed a measurement history data storing process and a waveform data storing process. The measurement history data is generated by correlating each information on the calculated measurement value, the number of shots (the number of injections), shot time (e.g., time of detecting the input of the trigger signal St in the step S101) and the result of abnormality determination with the mold number (“1” in this case) corresponding to the inputted trigger signal St. The waveform data is a waveform drawing data generated by using, e.g., the calculated measurement value.

The measurement data including the measurement history data and the waveform data is stored only in the measurement apparatus 1 or in both of the measurement apparatus 1 and the personal computer 3 according to the setting using the management software. At this time, the waveform data is stored in such a way that it is possible to identify the first mold 53-1 or the second mold 53-2 corresponding to the data (e.g., with the mold number associated therebetween).

The operation unit 10 returns to the step 5101 after the data storing process of the step S107.

Next, when the inputted trigger signal St is the second trigger signal St-2 in the step S102, the operation unit 10 proceeds to a step S108 and starts measurement for the second. mold and waveform data generation process. In other words, the operation unit 10 starts a pressure measurement value calculation process based on the input detection signal (the second detection signal Ss-2) of CH2 that is made to correspond to the mold number “2” by the setting and a waveform data generation process based. on the calculated pressure measurement value.

Next, the operation unit 10 starts a process of monitoring a measurement value for abnormality determination using the window W in a step S109, and determines whether or not the measurement value is abnormal in a step S110. In the abnormality determination process at the step S110, a window W set for the mold number corresponding to the inputted trigger signal St (in this case, the mold number “2” corresponding to the second trigger signal St-2) is selected according to the setting using the management software. The abnormality determination process is performed by using the selected window W.

When it is determined in the step S110 that the measurement value is not abnormal, the operation unit 10 proceeds to a step and performs a second mold measurement data storing process, i.e., a process of storing a measurement data obtained by the second mold measurement and waveform data generation process of the step S108. In the data storing process at the step S112, the measurement history data and the waveform data are stored as in the data storing process of the step S107. The measurement history data is generated by associating each information on the calculated measurement value, the number of shots, the shot time, and the result of abnormality determination with the mold number “2”. In the step S112, the measurement data including the measurement history data and the waveform data is stored in only the measurement apparatus 1 or in both of the measurement apparatus 1 and the personal computer 3 according to the setting using the management software. In this case, the waveform data is stored in such a way that it is possible to identify the mold corresponding to the data.

On the other hand, when it is determined in the step S110 that the measurement value is abnormal, the operation unit 10 proceeds to a step S111 and outputs the second alarm signal Sa-2, and then performs the data storing process in the step S112.

The operation unit 10 returns to the step S101 after the data storing process at the step S112.

The measurement apparatus (measurement apparatus 1) according to the first embodiment includes the first mold 53-1 and the second mold 53-2 and samples detection signals inputted as measurement target signals from the sensors (the first pressure sensor Sn-1 and the second pressure sensor Sn-2) installed at the injection molding apparatus 50 which selectively injects a molding material into each of the molds. The measurement apparatus 1 includes input terminals (the first trigger signal input terminal Tt-1 and the second trigger signal input terminal Tt-2) into which trigger signals outputted from the injection molding apparatus are inputted, the trigger signals indicating timing of injecting the molding material into the respective molds.

By using the measurement apparatus, it is possible to identify molds corresponding to the input trigger signals by checking input. terminals into which the trigger signals are inputted.

Therefore, it is possible to provide a measurement apparatus capable of separately performing measurement using the sensor detection signal on a mold basis. As a result, it is riot required to provide a measurement apparatus for each mold of the injection molding apparatus and, thus, the increase of the cost can be prevented.

The measurement apparatus according to the first embodiment includes the operation unit 10 configured to perform mold determination for determining a mold into which the molding material is being injected based on one of the input terminals to which each of the trigger signals is inputted and separately performing a measurement process using the detection signal on a mold basis depending on the result of mold determination.

Accordingly, the measurement process can be performed individually for each mold into which the molding material is injected.

Therefore, it is possible to provide a measurement apparatus capable of separately performing measurement using the sensor detection signal on a mold basis.

In the measurement apparatus according to the first embodiment, the operation unit determines individually whether or not the measurement value is abnormal using the detection signal in response to each input of a trigger signal and outputs an alarm signal when the operation unit determines that the measurement value is abnormal.

Accordingly, it is possible to perform individually the abnormality determination and output the alarm for each mold into which the molding material is injected. In other words, the abnormality determination and the alarm output can be performed individually for each mold without providing a measurement apparatus for each mold.

In the measurement apparatus according to the first embodiment, the operation unit selects an abnormality determination method to be used in the abnormality determination depending on the result of mold determination.

Accordingly, it is possible to switch the abnormality determination method on a mold basis.

As a result, the accuracy of the abnormality determination can be improved.

In the measurement apparatus according to the first embodiment, the sensor is configured as a pressure sensor for detecting a pressure of the molding material injected into a mold and the operation unit measures a pressure by using the detection signal. The pressure at which the molding material is injected into the mold (cavity) is an important factor in determining quality of molding.

Therefore, the measurement apparatus for performing pressure measurement contributes to product quality improvement.

In the measurement apparatus according to the first embodiment, the injection molding apparatus is a rotary table type injection molding apparatus in which the molds are provided on the rotary table.

In the rotary table type injection molding apparatus, the positions of the molds are changed by the rotation so that it is difficult for an operator or the like to identify a mold into which a molding material is being injected through eye observation.

The measurement apparatus according to the first embodiment is suitable for the rotary table type injection molding apparatus.

The first embodiment has been described as the example in which the pressure sensor Sn is provided for each mold. However, it is also possible to provide the pressure sensor Sn at the injection cylinder 55 and detect each pressure in the case where the upper mold 60 and the first mold 53-1 are closed and in the case where the upper mold 60 and the second mold 53-2 are closed, as disclosed in Japanese Patent Application Publication No. 2008-36975.

In that case, only the detection signal Ss of one channel is inputted to the measurement apparatus 1. However, the measurement apparatus 1 may perform the measurement process for the first mold. 53-1 or the second mold 53-2 depending on the inputted trigger signal St. In other words, in this case, it is not necessary to switch the detection. signal channel to be measured, depending on the trigger signal St. Further, it is not necessary to preset the correlation between the channel connected to the sensor and the mold number, in the measurement apparatus 1 by using the management software.

Although the case in which the A/D converter 12 is provided. for each channel of the detection signal Ss in the measurement apparatus 1 has been described, the respective channels may share a single A/D converter 12. In that case, there is provided a selector for selecting any one of the first detection signal Ss-1 and the second detection signal Ss-2 to be inputted through the terminal 11, and the operation unit 10 inputs the detection signal Ss-1 selected by the selector.

By providing the single A/D converter 12, an area of the substrate in the measurement apparatus 1 can be reduced. The cost of the measurement apparatus 1 can be decreased by decreasing a cost per channel.

Although the case in which the detection signal Ss of each pressure sensor Sn is inputted through the relay box 2 into the measurement apparatus 1 has been described, the detection signal from each pressure sensor Sn can be directly inputted to the measurement apparatus 1.

Hereinafter, a second embodiment will be described.

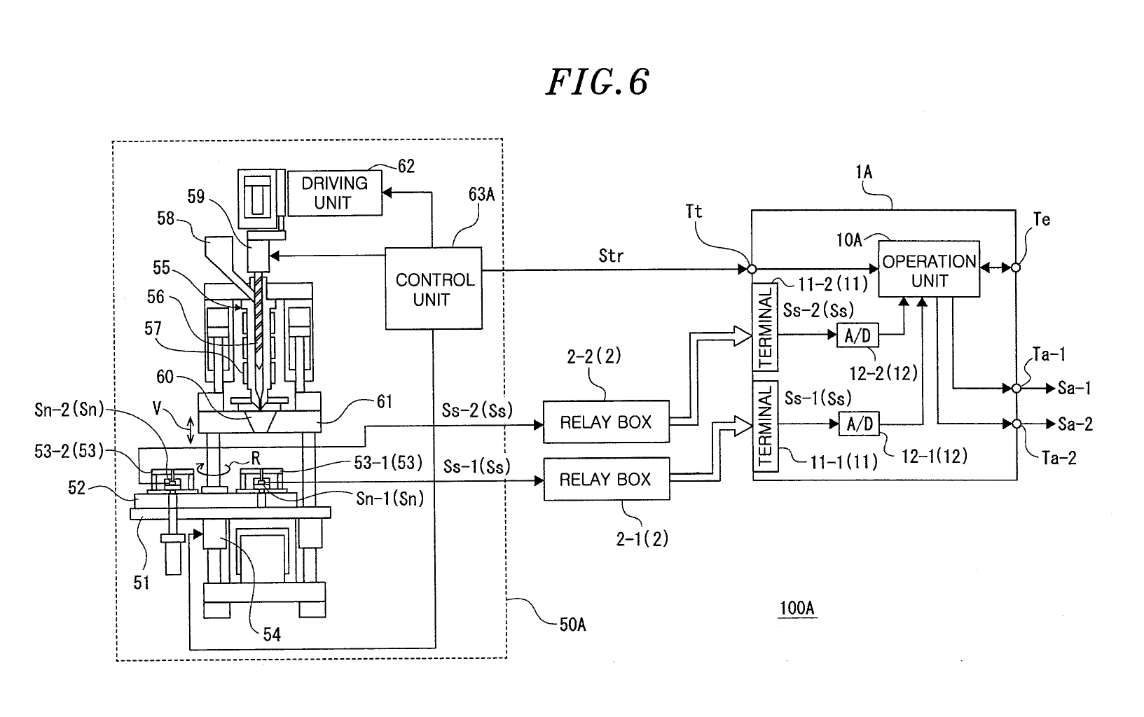

FIG. 6 shows a configuration of an injection. molding measurement system 100A according to the second embodiment.

In the second embodiment, like reference numerals will be used for like parts described, in the first embodiment and redundant description thereof will be omitted. In FIG. 6, the personal computer 3 is omitted for convenience of illustration.

In the injection molding measurement system 100A according to the second embodiment, a measurement apparatus 1A including terminals 11 to which relay cables are connected is used. The relay boxes 2 are provided as many as the number of molds (the lower molds 53). A single detection signal Ss is inputted to each of the relay boxes 2 and, then, the measurement apparatus 1A performs a measurement process for the detection signal inputted to each terminal 11. In this manner, the measurement process is performed individually on a mold basis.

In the injection molding measurement system 100A, the injection, molding apparatus 50A is provided instead of the injection molding apparatus 50 and the measurement apparatus 1A is provided instead of the measurement apparatus 1.

The injection molding apparatus 50A is different from the injection molding apparatus 50 in that a control unit. 63A is provided instead of the control unit 63. The control unit 63A is different from the control unit 63 in that a single trigger signal Str is outputted instead of the first trigger signal St-1 and the second trigger signal St-2. The trigger signal Str is a signal indicating a start timing of a single injection molding period which includes the first injection molding period and the second injection molding period (i.e., a signal corresponding to the first trigger signal St-1).

In this example, the injection molding apparatus 50A includes, as the lower mold 53, a first mold 53-1 and a second mold 53-2. As for the relay box 2, a relay box 2-1 and a relay box 2-2 are provided. A first detection signal Ss-1 is inputted to the relay box 2-1 and a second detection signal Ss-2 is inputted to the relay box 2-2.

The measurement apparatus 1A includes, as the terminal 11, a terminal 11-1 and a terminal 11-2. A relay box 2-1 is connected to the terminal 11-1 through a relay cable and a relay box 2-2 is connected to the terminal 11-2 through another relay cable.

In this example, information regarding that the first pressure sensor Sn-1 is connected to which one of the relay box 2-1 and the relay box 2-2, i.e., information regarding that the first detection signal Ss-1 is inputted to which one of the terminal 11-1 and the terminal 11-2, and the information regarding that the second pressure sensor Sn-2 is connected to which one of the relay box 2-1 and the relay box 2-2, i.e., the information regarding that the second detection signal Ss-2 is inputted to which one of the terminal 11-1 and the terminal 11-2, are preset in the measurement apparatus 1A by using the management software.

Further, the information on an input terminal of a channel in the relay box 2-1 to which the first pressure sensor Sn-1 is connected (information on a channel in the relay box 2-1 into which the first detection signal Ss-1 is inputted) and the information on an input terminal of a channel in the relay box 2-2 to which the second pressure sensor Sn-2 is connected (information on a channel in the relay box 2-2 into which the second detection signal Ss-2 is inputted) are preset in the measurement apparatus 1A by using the management software.

Although it is not illustrated, in the measurement apparatus 1A, the A/D converters 12 are provided, for each terminal 11, as much as the number of the channels into which signals can be inputted (four channels in this example). Among the A/D converters 12 provided for each terminal 11, only the A/D converters 12-1 and 12-2 corresponding to the channels into which the first detection signal Ss-1 and the second detection signal Ss-2 are inputted. are illustrated in FIG. 6. The first detection signal Ss-1 is inputted to the A/D converter 12-1 through the terminal 11-1, and the second detection signal Ss-2 is inputted to the A/D converter 12-2 through the terminal 11-2.

In the measurement apparatus 1A, only a trigger signal input terminal Tt is provided as the trigger signal input terminal. A trigger signal Str is inputted from the control unit 63A into the corresponding trigger signal input terminal Tt.

In the measurement apparatus 1A, the operation unit 10A is provided instead of the operation unit 10. The trigger signal Str and the first detection signal Ss-1 and the second detection signal Ss-2 that have been A/D converted are inputted to the operation unit 10A.

The operation unit 10A performs, in response to the input of the trigger signal Str, a measurement process using the detection signal Ss inputted through the terminal 11-1 and a measurement process using the detection signal Ss inputted through the terminal 11-2.

Specifically, in this example, the operation unit 10 performs, based on information, preset by the management software, on correlation between the mold number and the terminal 11 and information on a channel set for each terminal 11, the measurement process using the detection signal Ss (i.e., the first detection signal Ss-1) inputted to the set channel for the terminal 11-1 corresponding to the mold number “1” and the measurement process using the detection signal Ss (i.e., the second detection signal Ss-2) inputted to the set channel for the terminal 11-2 corresponding to the mold number “2”.

In the former measurement process, the measurement history data associated with the mold number “1” set for the terminal 11-1 is generated and stored. In the latter measurement process, the measurement history data associated with the mold number “2” set for the terminal 11-2 is generated and stored. At this time, in the case of storing the waveform data in each measurement process, the data is stored in such a way that it is possible to identify the mold corresponding to the data.

In the latter measurement process, a large time lag exists from the input timing of the trigger signal Str to the rise timing of the detection signal Ss, compared to the former measurement process. Thus, when it is determined whether not the measurement value is abnormal, the monitoring period ws of the window w is set in consideration of the time lag.

The second embodiment can also provide the measurement apparatus capable of separately performing measurement using the sensor detection signal on a mold basis.

Therefore, in the injection molding measurement system which includes the injection molding apparatus for selectively injecting a molding material into each of molds, it is not required to provide a measurement apparatus for each mold of the injection molding apparatus. Accordingly, the increase of the cost can be prevented.

The case in which the correlation between the mold number and the detection signal Ss can be arbitrarily set in the measurement apparatus 1A has been described in the above. However, it may not be necessary to preset the correlation among the detections signals Ss, the terminal 11, and the channels in the measurement apparatus 1A when the measurement apparatus 1A operates such that the detection signal Ss inputted to a predetermined channel of the terminal 11-1 is recognized as a detection signal Ss (i.e., the first detection signal Ss-1) corresponding to the mold number and the detection signal Ss inputted to a predetermined channel of the terminal 11-2 is recognized as a detection signal Ss (i.e., the second detection signal Ss-2) corresponding to the mold number “2”.

While the embodiments of the disclosure have been described, the disclosure is not limited to the above-described examples and may be variously modified.

Although the example in which the measurement apparatus is applied to the rotary table type injection molding apparatus has been described, the measurement apparatus may be applied to an injection molding apparatus for selectively injecting a molding material into each of the molds, e.g., a slide type injection molding apparatus capable of injecting a molding material into each of the molds provided on a slide stage capable of sliding in a horizontal direction or the like.

The measurement. apparatus of the disclosure is not limited to a vertical type apparatus and may also be suitable for another injection molding apparatus such as a horizontal type apparatus or the like.

Although the measurement apparatus for performing pressure measurement has been described, the measurement apparatus of the disclosure may also be suitable for the case of performing another measurement for injection molding such as measurement of a temperature of a molding surface or a molding material using a detection signal of a temperature sensor, measurement of a flow speed of the molding material using a detection signal of an optical sensor, measurement of a flow front using a detection signal of an infrared sensor (e.g., measurement of time until the molding material reaches a predetermined position in the cavity), measurement of position deviation between molds in the case of closing the molds using a detection signal of a position sensor (measurement of a distance between the molds), or the like.

When the measurement other than pressure measurement is performed, the abnormality determination method can be switched on an inputted trigger signal basis.

While the disclosure has been shown and described with respect to the embodiments, it will be understood by those skilled in the art that various changes and modifications may be made without departing from the scope of the disclosure as defined in the following claims.

What is claimed is:

1. A measurement apparatus for receiving a detection signal as a measurement target signal from a sensor provided at an injection molding apparatus which includes molds and selectively injects a molding material into each of the molds, the apparatus comprising:
input terminals to which trigger signals outputted from the injection molding apparatus are inputted, the trigger signals indicating timing of injecting the molding material into each of the molds.

2. The measurement apparatus of claim 1, further comprising an operation unit configured to perform mold determination for determining a mold into which the molding material is being injected based on one of the input terminals to which each of the trigger signals is inputted and separately perform a measurement process using the detection signal on a mold basis depending on the result of the mold determination.

3. The measurement apparatus of claim 2, wherein the operation unit performs abnormality determination to determine whether or not a measurement value is abnormal using the detection signals in response to each input of the trigger signals, and
wherein when the operation unit determines that the measurement value is abnormal, an alarm signal for the mold determined in the mold determination is outputted.

4. The measurement apparatus of claim 2, wherein the operation unit selects an abnormality determination method to be used in the abnormality determination depending on the result of the mold determination.

5. The measurement apparatus of claim 3, wherein the operation unit selects an abnormality determination method to be used in the abnormality determination depending on the result of the mold determination.

6. The measurement apparatus of claim 1, wherein the sensor is a pressure sensor for detecting a pressure of the molding material injected into the mold, and the operation unit performs a pressure measurement using the detection signal.

7. The measurement apparatus of claim 2, wherein the sensor is a pressure sensor for detecting a pressure of the molding material injected into the mold, and the operation unit performs a pressure measurement using the detection signal.

8. The measurement apparatus of claim 3, wherein the sensor is a pressure sensor for detecting a pressure of the molding material injected into the mold, and the operation unit performs a pressure measurement using the detection signal.

9. The measurement apparatus of claim 4, wherein the sensor is a pressure sensor for detecting a pressure of the molding material injected into the mold, and the operation unit performs a pressure measurement using the detection signal.

10. The measurement apparatus of claim 1, wherein the injection molding apparatus is a rotary table type injection molding apparatus in which the molds are provided on a rotary table.

11. The measurement apparatus of claim 2, wherein the injection molding apparatus is a rotary table type injection molding apparatus in which the molds are provided on a rotary table.

12. The measurement apparatus of claim 3, wherein the injection molding apparatus is a rotary table type injection molding apparatus in which the molds are provided on a rotary table.

13. The measurement apparatus of claim 4, wherein the injection molding apparatus is a rotary table type injection molding apparatus in which the molds are provided on a rotary table.

14. The measurement apparatus of claim 5, wherein the injection molding apparatus is a rotary table type injection molding apparatus in which the molds are provided on a rotary table.
